(19) United States
(12) Patent Application Publication
(10) Pub. No.: US 2026/0095580 A1
(43) Pub. Date: Apr. 2, 2026

(54) Video Encoding Method, Electronic Device and Non-Transitory Readable Storage Medium

(71) Applicant: VIVO MOBILE COMMUNICATION CO.,LTD., Dongguan (CN)

(72) Inventors: Dabin Zeng, Dongguan (CN); Jun Fu, Dongguan (CN)

(21) Appl. No.: 19/411,503

(22) Filed: Dec. 8, 2025

Related U.S. Application Data
(63) Continuation of application No. PCT/CN2024/100314, filed on Jun. 20, 2024.

(30) Foreign Application Priority Data
Jun. 26, 2023 (CN) 202310763796.5

(51) Int. Cl. H04N 19/20; H04N 19/17

(52) U.S. Cl. CPC H04N 19/20; H04N 19/17

(57) ABSTRACT

A video encoding method includes: obtaining an affine transformation matrix based on image data of at least two collected video frames and first data, where the affine transformation matrix is used to indicate a mapping relationship between corresponding macroblocks in every two adjacent video frames of the at least two video frames, and the first data is acceleration data and angular velocity data of an electronic device in a process of collecting the at least two video frames; determining a first object based on the affine transformation matrix; and encoding the at least two video frames based on the first object, where the first object includes at least one of the following: an encoding search range of each macroblock in the at least two video frames, or an intra-coded frame of the at least two video frames.

### CROSS-REFERENCE TO RELATED APPLICATIONS

This application is a Bypass Continuation Application of International Patent Application No. PCT/CN2024/100314 filed June 20, 2024, and claims priority to Chinese Patent Application No. 202310763796.5 filed June 26, 2023, the disclosures of which are hereby incorporated by reference in their entireties.

### BACKGROUND OF THE INVENTION

### FIELD OF THE INVENTION

This application belongs to the field of video technologies, and in particular, relates to a video encoding method, an electronic device, and a non-transitory readable storage medium.

### DESCRIPTION OF RELATED ART

Currently, when encoding a plurality of collected video frames, an electronic device needs to perform at least one of the following operations: determining an encoding search range of each macroblock in the plurality of video frames to identify redundant information among the plurality of video frames, and then performing compression processing on the redundant information; or determining an intra-coded frame of the plurality of video frames based on an image content change degree of each video frame, to increase a video frame compression rate and reduce a volume of an encoded video.

### SUMMARY OF THE INVENTION

According to a first aspect, an embodiment of this application provides a video encoding method, where the method includes: obtaining an affine transformation matrix based on image data of at least two collected video frames and first data, where the affine transformation matrix is used to indicate a mapping relationship between corresponding macroblocks in every two adjacent video frames of the at least two video frames, and the first data is acceleration data and angular velocity data of an electronic device in a process of collecting the at least two video frames; determining a first object based on the affine transformation matrix; and encoding the at least two video frames based on the first object, where the first object includes at least one of the following: an encoding search range of each macroblock in the at least two video frames, or an intra-coded frame of the at least two video frames.

According to a second aspect, an embodiment of this application provides a video encoding apparatus, where the apparatus includes an obtaining module, a determining module, and an encoding module, where the obtaining module is configured to obtain an affine transformation matrix based on image data of at least two collected video frames and first data, where the affine transformation matrix is used to indicate a mapping relationship between corresponding macroblocks in every two adjacent video frames of the at least two video frames, and the first data is acceleration data and angular velocity data of an electronic device in a process of collecting the at least two video frames; the determining module is configured to determine a first object based on the affine transformation matrix obtained by the obtaining module; and the encoding module is configured to encode the at least two video frames based on the first object determined by the determining module, where the first object includes at least one of the following: an encoding search range of each macroblock in the at least two video frames, or an intra-coded frame of the at least two video frames.

According to a third aspect, an embodiment of this application provides an electronic device. The electronic device includes a processor and a memory, the memory stores a program or instructions executable on the processor, and when the program or the instructions are executed by the processor, the steps of the method according to the first aspect are implemented.

According to a fourth aspect, an embodiment of this application provides a non-transitory readable storage medium. The non-transitory readable storage medium stores a program or instructions, and when the program or the instructions are executed by a processor, the steps of the method according to the first aspect are implemented.

According to a fifth aspect, an embodiment of this application provides a chip. The chip includes a processor and a communication interface, the communication interface is coupled to the processor, and the processor is configured to run a program or instructions to implement the method according to the first aspect.

According to a sixth aspect, an embodiment of this application provides a computer program product. The program product is stored in a non-transitory storage medium, and the program product is executed by at least one processor to implement the method according to the first aspect.

### BRIEF DESCRIPTION OF THE DRAWINGS

FIG. 1 is a schematic diagram of a diamond search method in a conventional encoding process;

FIG. 2 is a flowchart 1 of a video encoding method according to an embodiment of this application;

FIG. 3 is a schematic diagram of affine transformation of pixels in a video encoding method according to an embodiment of this application;

FIG. 4 is a flowchart 2 of a video encoding method according to an embodiment of this application;

FIG. 5 is a flowchart 3 of a video encoding method according to an embodiment of this application;

FIG. 6 is a schematic diagram of determining an encoding search range of a macroblock in a video encoding method according to an embodiment of this application;

FIG. 7 is a flowchart 4 of a video encoding method according to an embodiment of this application;

FIG. 8 is a flowchart 5 of a video encoding method according to an embodiment of this application;

FIG. 9 is a flowchart 6 of a video encoding method according to an embodiment of this application;

FIG. 10 is a schematic diagram of a video encoding apparatus according to an embodiment of this application;

FIG. 11 is a schematic diagram of an electronic device according to an embodiment of this application; and

FIG. 12 is a schematic diagram of hardware of an electronic device according to an embodiment of this application.

### DESCRIPTION OF THE INVENTION

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on the embodiments of this application shall fall within the protection scope of this application.

In the specification and claims of this application, the terms "first" and "second" are used to distinguish between similar objects, but are unnecessarily used to describe a specific sequence or order. It should be understood that, data used in this way may be interchangeable under appropriate circumstances, so that the embodiments of this application can be implemented in an order other than that illustrated or described herein. Moreover, the terms such as "first", "second", and the like typically distinguish between objects of one category rather than limiting a quantity of objects. For example, there may be one or more first objects. In addition, in the specification and claims, "and/or" represents at least one of the connected objects, and the character "/" usually represents an "or" relationship between associated objects.

The terms "at least one (item)", "at least one of", and the like in the specification and claims of this application refer to any one, any two, or a combination of any two or more of included objects. For example, at least one (item) of a, b, and c may represent: "a", "b", "c", "a and b", "a and c", "b and c", and "a, b, and c", where a, b, and c may be singular or plural. Similarly, "at least two (items)" means two or more, and a meaning thereof is similar to that of "at least one (item)".

In the following, some nouns or terms in the specification and claims of this application are first explained.

Macroblock: The macroblock is a basic concept in a video encoding technology, where a picture is divided into blocks of different sizes to implement different compression strategies at different locations. In video encoding, an image of a video frame is usually divided into several blocks of a same size, which are referred to as macroblocks. A size of the macroblock may be 16×16, 16×8, 8×16, 8×8, or the like, but a minimum size may be 4×4.

Intra-coded frame (namely, I-frame): The intra-coded frame is also referred to as an intra frame or a key frame, is an important frame in inter-frame compression encoding, and belongs to intra-frame compression. A picture of the I-frame is fully preserved. When the I-frame is decoded, a complete image can be reconstructed only by using data of this frame. The I-frame method is an intra-frame compression method, which is also referred to as a key-frame compression method. The I-frame method is a compression technology based on discrete cosine transform (DCT). With I-frame compression, a compression ratio of 1/6 can be achieved without obvious compression artifacts.

Unidirectional predictive-coded frame (namely, P-frame): The unidirectional predictive-coded frame is also referred to as a difference frame, and belongs to inter-frame compression. An encoded P-frame represents difference information between a current frame and an I-frame, or a previous P-frame of the current frame. When the P-frame is decoded, a buffered picture of a previous P-frame or I-frame of the current frame needs to be overlaid with encoded difference information defined by this frame to reconstruct a picture of the current frame. The P-frame method compresses data of this frame based on a difference between this frame and an adjacent previous frame (I-frame or P-frame). With the joint compression method of the P-frame and the I-frame, a higher compression ratio can be achieved without obvious compression artifacts.

Bidirectional predictive-coded frame (namely, B-frame): The bidirectional predictive-coded frame is also referred to as a bidirectional difference frame. An encoded B-frame records difference information between this frame (namely, a current frame) and previous and subsequent frames. In other words, to decode the B-frame, not only a previously buffered picture needs to be obtained, but also a subsequent picture needs to be decoded, and an image of this frame is reconstructed by using the previous and subsequent frames and encoded data of this frame. The B-frame method is a bidirectional predictive inter-frame compression algorithm. When a frame is compressed into a B-frame, the method compresses this frame based on a difference between data of a previous frame, this frame, and a subsequent frame that are adjacent to each other. High compression of 200:1 can be achieved only through B-frame compression.

Electronic image stabilization algorithm: The electronic image stabilization algorithm is an algorithm that compensates for displacement of an image in a video frame collected by a camera, to achieve a stable effect. The electronic image stabilization algorithm generally includes the following steps: (1) Image stabilization processing is performed on a video frame collected by the camera. This can be achieved by calculating displacement of each video frame relative to a previous frame. Stabilization processing allows smooth transition between images, and avoids jitter caused by camera shake. (2) Motion of the camera is estimated. An acceleration, a speed, a direction, and other information of the camera in a motion process may be estimated by calculating a displacement change between two adjacent frames. (3) Based on a result of motion estimation, pixels in the video frame are compensated for. A commonly used method is to perform transformation such as displacement, rotation, and scaling on the video frame, so that a pixel location in the video frame can be aligned with that in the previous frame.

With reference to the accompanying drawings, a video encoding method and apparatus, an electronic device, and a non-transitory readable storage medium that are provided in the embodiments of this application are described in detail below by using some embodiments and application scenarios thereof.

Mainstream encoding methods mainly include a Moving Picture Experts Group (MPEG) 1 encoding method, an MPEG-2 encoding method, an MPEG-4 encoding method, and an H.26X encoding method.

MPEG-1 is the first lossy video and audio compression standard formulated by the MPEG organization, mainly uses block-based motion compensation, discrete cosine transform, quantization, and other technologies, and is optimized for a transmission rate of 1.2 Mbps. MPEG-1 has the following main features: random access, a flexible frame rate, a variable image size, definition of the I-frame, the P-frame and the B-frame, motion compensation that can span a plurality of frames, a motion vector with half-pixel precision, a quantization matrix, and the like.

MPEG-2 is another lossy video and audio compression standard formulated by MPEG organization after MPEG-1. Compared with the MPEG-1 encoding method, use of the MPEG-2 encoding method for encoding can make an encoded image have higher image quality, more image formats, and a higher transmission bit rate. MPEG-2 is a compression scheme for a standard-definition digital television and a high-definition television in a variety of applications, with a transmission rate ranging from 3 Mbit/s to 10 Mbit/s. A principle of MPEG-2 utilizes two characteristics of an image: spatial correlation and temporal correlation. Any scene in a frame of image includes several pixels, and therefore one pixel usually has a specific relationship with some pixels around the pixel in terms of luminance and chrominance. This relationship is referred to as spatial correlation. A segment in a program usually includes an image sequence including several frames of consecutive images, and there is also a specific relationship between previous and subsequent frames of images in an image sequence. This relationship is referred to as temporal correlation. The two types of correlation result in a large amount of redundant information in the image. Use of the MPEG-2 encoding method for encoding can remove the redundant information and retain only a small amount of irrelevant information for transmission, thereby greatly saving a transmission bandwidth, and improving encoding efficiency.

MPEG-4 is another lossy video and audio compression standard formulated by the MPEG organization after MPEG-2. Compared with MPEG-1 and MPEG-2, MPEG-4 not only aims at video and audio encoding at a specific bit rate, but also pays more attention to interactivity and flexibility of multimedia systems. MPEG-4 is mainly used in video telephony, video e-mail, electronic news, and the like, with a relatively low transmission rate requirement, ranging from 4800 bits/s to 64000 bits/s. In MPEG-4, a very narrow bandwidth is used, so that best image quality is achieved with a least amount of data through frame reconstruction technologies, compression, and data transmission. MPEG-4 proposes some new and innovative key technologies, including video object extraction technologies, video object plane video encoding technologies, scalable video encoding technologies, motion estimation and motion compensation technologies, and the like.

H.26X is a new-generation digital video encoding standard jointly proposed by the International Organization for Standardization and the International Telecommunication Union. Taking H.264 as an example, main parts of the H.264 standard include: an access unit delimiter, supplemental enhancement information, basic image coding, redundant image coding, instantaneous decoding refresh, hypothetical reference decoder, and a hypothetical bitstream scheduler. H.264 is built based on the MPEG-4 technology. Encoding and decoding processes thereof mainly include five parts: inter prediction and intra prediction, transformation and inverse transformation, quantization and dequantization, loop filtering, and entropy coding. Use of the H.264 encoding method for encoding has the following advantages: 1. Low bit rate: under same image quality, an amount of data obtained after compression by using the H.264 technology is only 1/8 of that of MPEG-2 and 1/3 of that of MPEG-4. 2. High-quality image: H.264 can provide continuous and smooth high-quality images. 3. Strong error resilience: H.264 provides a necessary tool to address errors such as packet loss that are prone to occur in an unstable network environment. 4. Strong network adaptability: H.264 provides a network abstraction layer, so that H.264 files can be easily transmitted over different networks.

Currently, when the electronic device uses any one of the foregoing encoding methods to encode a plurality of video frames collected by the camera, the electronic device usually needs to perform at least one of the following step A or step B:

Step A. The electronic device determines an encoding search range of each macroblock in the plurality of video frames, to identify inter-frame redundant information among the plurality of video frames, and compresses the identified redundant information by using a data compression technology, to reduce an amount of data in a transmission process and a burden of storing information.

The electronic device can determine the encoding search range (including an encoding search radius and an encoding search direction) by traversing a plurality of pixels around each pixel in each macroblock in the plurality of video frames by using a search algorithm. This search algorithm mainly includes a diamond search method, a hexagon search method, a full search method, and the like.

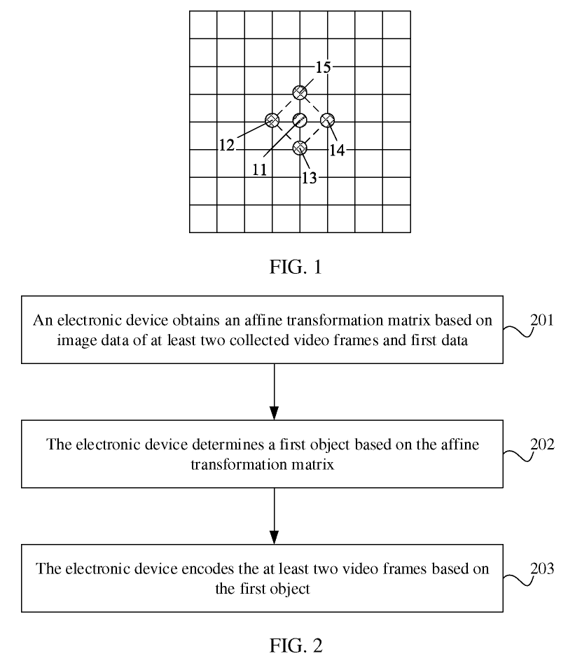

For example, taking the diamond search method as an example, as shown in FIG. 1, a pixel 11 is a vertex of a macroblock. The electronic device may traverse four pixels in four directions around the pixel 11, namely, a pixel 12 to the left of the pixel 11, a pixel 13 below the pixel 11, a pixel 14 to the right of the pixel 11, and a pixel 15 above the pixel 11. Therefore, after traversing four pixels around each pixel in the macroblock, the electronic device may determine an encoding search range of the macroblock by comparing pixel values.

It should be noted that, in the embodiments of this application, "above", "below", "left", and "right" are illustrated by using an example in which a screen of the electronic device faces a user when the screen displays an interface.

It may be understood that, the electronic device determines an encoding search range of each macroblock in the plurality of video frames by traversing a plurality of pixels around each pixel in each macroblock. Therefore, the electronic device needs to perform a large amount of calculation when determining the encoding search range of each macroblock. In particular, when an amount of motion between two adjacent frames is large, a relatively large difference between image content increases a quantity of pixels that the electronic device needs to traverse, which increases computing load of the electronic device, and additionally consumes encoding performance, resulting in relatively large power consumption of the electronic device in a video encoding process.

Step B. The electronic device determines an intra-coded frame of the plurality of video frames based on an image content change degree of each video frame, to increase a video frame compression rate and reduce a volume of an encoded video. The electronic device may determine the intra-coded frame by comparing pixel changes of macroblocks in the plurality of video frames.

For example, the electronic device may first set a maximum value of an inter-frame spacing for the intra-coded frame, and then select, as the intra-coded frame, a video frame with a significant change in image content within a range of the inter-frame spacing. The method for determining a video frame with a significant change in image content is: comparing pixel changes of macroblocks in the plurality of video frames, and determining, as the video frame with a significant change in image content, a video frame in which a macroblock with a pixel change degree exceeding a threshold is located. Clearly, because comparing pixel changes of macroblocks in the plurality of video frames also requires a large amount of calculation by the electronic device, the electronic device also needs to consume considerable computing load to determine a suitable intra-coded frame from the plurality of video frames. This also leads to relatively large power consumption of the electronic device in a video encoding process.

To resolve the problem of relatively large power consumption of the electronic device in the video encoding process, the embodiments of this application provide a video encoding method and apparatus, an electronic device, and a non-transitory readable storage medium. The video encoding method provided in the embodiments of this application may be applied in a scenario in which a mobile phone encodes a collected video frame.

For example, the mobile phone collects N (N is an integer greater than or equal to 2) video frames (for example, at least two video frames in the embodiments of this application), and obtains acceleration data and angular velocity data of the mobile phone (for example, first data in the embodiments of this application) in a process of collecting the N video frames. Then, the mobile phone may obtain, based on image data of the N video frames and the obtained acceleration data and angular velocity data of the mobile phone, a matrix (for example, an affine transformation matrix in the embodiments of this application) used to indicate a mapping relationship between corresponding macroblocks in every two adjacent video frames of the N video frames. Next, the mobile phone may determine, based on the matrix, at least one of the following: an encoding search range of each macroblock in the N video frames, or an intra-coded frame of the N video frames. Therefore, the mobile phone may encode the N video frames based on at least one of the determined encoding search range or the determined intra-coded frame.

According to the solution of this application, when determining the encoding search range of each macroblock in the N collected video frames, the mobile phone may directly determine the encoding search range based on the matrix used to indicate a mapping relationship between corresponding macroblocks in adjacent video frames, without traversing a plurality of pixels around each pixel in each macroblock. In addition, when determining the intra-coded frame of the N video frames, the electronic device may also directly determine the intra-coded frame based on the matrix, without comparing pixel changes of macroblocks in the N video frames. Therefore, when the N video frames are encoded based on at least one of the encoding search range or the intra-coded frame, computing load of the electronic device can be greatly reduced, thereby reducing power consumption of the electronic device.

It should be noted that the video encoding method provided in the embodiments of this application may be performed by a video encoding apparatus, an electronic device, a functional module in an electronic device, or the like. In some embodiments of this application, the video encoding method provided in the embodiments of this application is described by using an example in which the electronic device performs the video encoding method.

FIG. 2 is a flowchart of a video encoding method according to an embodiment of this application. As shown in FIG. 2, the video encoding method provided in this embodiment of this application may include the following step 201 to step 203.

Step 201. An electronic device obtains an affine transformation matrix based on image data of at least two collected video frames and first data.

The affine transformation matrix is used to indicate a mapping relationship between corresponding macroblocks in every two adjacent video frames of the at least two video frames, and the first data is acceleration data and angular velocity data of the electronic device in a process of collecting the at least two video frames.

For example, it is assumed that the at least two video frames include a video frame 1, a video frame 2, a video frame 3, and a video frame 4. The every two adjacent video frames include: the video frame 1 and the video frame 2, the video frame 2 and the video frame 3, and the video frame 3 and the video frame 4.

Optionally, in this embodiment of this application, the at least two video frames are video frames continuously collected by the electronic device.

Optionally, in this embodiment of this application, the at least two video frames may be collected by the electronic device by using a camera in the electronic device.

Optionally, in this embodiment of this application, the camera may be a conventional optical camera, an infrared camera, a time of flight (TOF) camera, or the like in the electronic device.

For example, taking the camera as the conventional optical camera as an example, the camera may be a long-focus camera, a short-focus camera, a zoom camera, or the like.

Optionally, in this embodiment of this application, the at least two video frames may be a sequence of video frames arranged in a fixed sequence, and the fixed sequence may be determined based on a time sequence in which each of the at least two video frames is collected.

For example, it is assumed that the at least two video frames include a video frame A collected at a time a, a video frame B collected at a time b, and a video frame C collected at a time c, and a sequence of the time a, the time b, and the time c is: the time b, the time a, and the time c. In this case, the sequence of video frames arranged in the fixed sequence may be the video frame B, the video frame A, and the video frame C. It may be learned that the fixed sequence is determined based on the sequence of the time a, the time b, and the time c.

Optionally, in this embodiment of this application, the image data may include pixel coordinate data of a pixel, a pixel value of a pixel, or the like.

Optionally, in this embodiment of this application, the first data may be obtained by the electronic device by using an inertial measurement unit (IMU) sensor in the electronic device in a process of collecting the at least two video frames.

It should be noted that the IMU sensor may be configured to collect data such as an acceleration, an angular velocity, tilt, impact, vibration, rotation, multi-degree-of-freedom motion, or the like.

Optionally, in this embodiment of this application, the IMU sensor may include a timer and a first input first output (FIFO) stack. The IMU sensor may generate an interrupt at a fixed time interval by using the timer, perform data collection, store a record of collected sampling data to the FIFO stack after each data collection, and send an interrupt signal to a processor in the electronic device, to notify the processor to read the sampling data collected by the IMU sensor at the fixed time interval. In this way, the processor may read the sampling data after receiving the interrupt signal.

Optionally, in this embodiment of this application, the acceleration data may be all acceleration data sampled by the IMU sensor in the process of collecting the at least two video frames, or may be one piece of acceleration data obtained after linear fitting is performed on all the acceleration data, or may be one piece of acceleration data obtained after all the acceleration data is averaged.

Optionally, in this embodiment of this application, the angular velocity data may be all angular velocity data sampled by the IMU sensor in the process of collecting the at least two video frames, or may be one piece of angular velocity data obtained after linear fitting is performed on all the angular velocity data, or may be one piece of angular velocity data obtained after all the angular velocity data is averaged.

Optionally, in this embodiment of this application, the mapping relationship between the corresponding macroblocks in the every two adjacent video frames of the at least two video frames is an affine transformation relationship of the corresponding macroblocks.

Optionally, in this embodiment of this application, corresponding macroblocks in two adjacent video frames include a plurality of groups of macroblocks, and each group of macroblocks includes one macroblock (hereinafter referred to as a macroblock 1) in one video frame of the two adjacent video frames and one macroblock (hereinafter referred to as a macroblock 2) in the other video frame of the two adjacent video frames. In addition, a degree of similarity between a pixel value of a pixel in the macroblock 1 and a pixel value of a pixel in the macroblock 2 is greater than or equal to a preset degree of similarity.

It may be understood that the two macroblocks in each group of macroblocks correspond to a same object in images of respective video frames.

For example, it is assumed that a video frame a and a video frame b are two adjacent video frames, and the two video frames record a flight track of a bird. If a macroblock A in the video frame a corresponds to the bird in an image of the video frame a, a macroblock B that is in the video frame b and that corresponds to the macroblock A corresponds to the bird in an image of the video frame b.

It should be noted that affine transformation is also referred to as affine mapping, which means that a vector space in geometry undergoes non-singular linear transformation followed by translation transformation, to be transformed into another vector space. In a finite dimensional case, each affine transformation may be given by a matrix A and a vector b, which may be written as A and an additional column b. One affine transformation corresponds to multiplication of one matrix and one vector, and composition of affine transformations corresponds to common matrix multiplication, provided that an additional row is added to the bottom of the matrix, where this row is all 0 except for 1 in the rightmost entry, and 1 is added to the bottom of the column vector.

The affine transformation relationship is described below by using one pixel in a macroblock as an example.

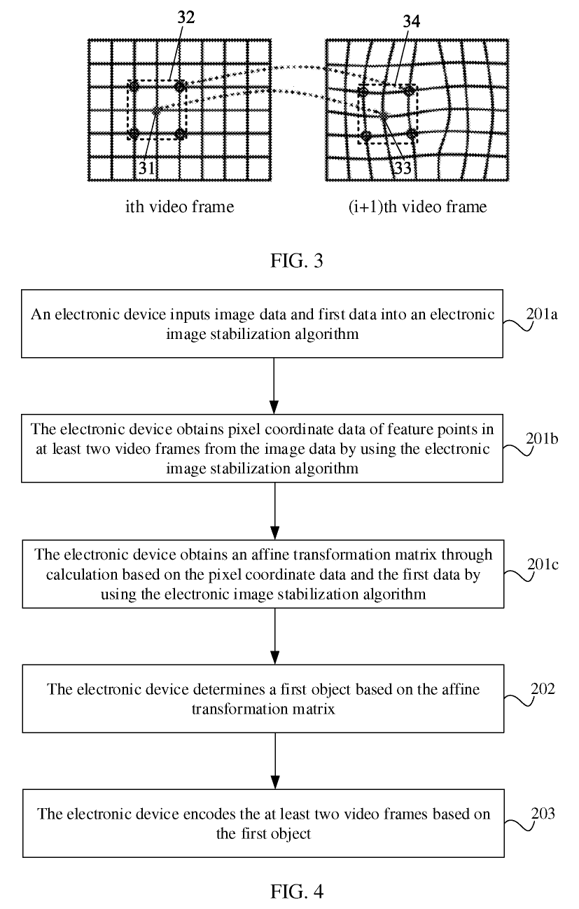

For example, it is assumed that the any two adjacent video frames are an ith video frame and an (i+1)th video frame of the at least two video frames, and i is a positive integer. In this case, as shown in FIG. 3, a pixel 31 is a central pixel in a macroblock 32 in the ith video frame. Due to jitter in a process of collecting the at least two video frames by the electronic device, a macroblock 34 that is in the (i+1)th video frame and that corresponds to the macroblock 32 is distorted. Therefore, a geometric location of a pixel 33 that is in the macroblock 34 and that corresponds to the pixel 31 is changed, and this geometric location transformation relationship is an affine transformation relationship between the pixel 31 and the pixel 33.

Optionally, in this embodiment of this application, the affine transformation relationship may be recorded by using the affine transformation matrix, so that the affine transformation matrix can indicate a mapping relationship between corresponding macroblocks in any two adjacent video frames of the at least two video frames.

Optionally, in this embodiment of this application, the affine transformation matrix may include at least two sub-matrices, each of the at least two sub-matrices corresponds to one of the at least two video frames, and each sub-matrix is used to indicate a geometric location of a macroblock in a corresponding video frame.

Optionally, in this embodiment of this application, a geometric location of a macroblock in a video frame may be determined by using a coordinate value of a pixel in the macroblock.

Optionally, in this embodiment of this application, a value in each sub-matrix may include a coordinate value of a pixel in a corresponding video frame.

For example, it is assumed that a macroblock 5 in a video frame 5 includes a pixel 1, a pixel 2, a pixel 3, and a pixel 4, and the four pixels are four vertices of the macroblock 5. If a coordinate value of the pixel 1 is (2, 2), a coordinate value of the pixel 2 is (4, 2), a coordinate value of the pixel 3 is (2, 4), and a coordinate value of the pixel 4 is (4, 4), a geometric location of the macroblock 5 in the video frame 5 may be clearly determined by using the coordinate values of the four pixels.

Optionally, in this embodiment of this application, the at least two sub-matrices may be arranged in the foregoing fixed sequence.

Optionally, in this embodiment of this application, any two adjacent sub-matrices of the at least two sub-matrices may be used to indicate a mapping relationship between corresponding macroblocks in two adjacent video frames of the at least two video frames.

In this embodiment of this application, the affine transformation matrix may include the at least two sub-matrices that are in a one-to-one correspondence with the at least two video frames, and each sub-matrix may be used to indicate a geometric location of a macroblock in a corresponding video frame. Therefore, when the electronic device needs to obtain the mapping relationship between the corresponding macroblocks in the any two adjacent video frames, only sub-matrices corresponding to the any two adjacent video frames need to be used, without considering another sub-matrix, thereby reducing computing load and power consumption of the electronic device.

Optionally, in this embodiment of this application, with reference to FIG. 1, as shown in FIG. 4, the foregoing step 201 may be implemented by using the following step 201a to step 201c.

Step 201a. The electronic device inputs the image data and the first data into an electronic image stabilization algorithm.

In this embodiment of this application, the image data is image data of the at least two video frames.

In this embodiment of this application, the electronic image stabilization algorithm is a commonly used algorithm used to alleviate a jitter problem of the electronic device when a video is photographed. The electronic image stabilization algorithm may work with a gyroscope (namely, an apparatus that detects angular motion around one or two axes orthogonal to a rotation axis relative to an inertial space by using a momentum-sensitive housing of a high-speed rotating body) in the electronic device.

For example, in a video photographing process, when the gyroscope detects vibration of the electronic device, the electronic image stabilization algorithm may analyze and collect an image on the sensor, dynamically adjust a sensitivity, a shutter, and the like to perform blur correction by calculating a rotation change of a posture of the electronic device, and perform dynamic cropping on a video frame, to reduce impact of electronic device jitter on photographing, and effectively improve video picture stability.

Optionally, in this embodiment of this application, the electronic image stabilization algorithm may be used to obtain a motion vector of a pixel based on image content of a video frame or the IMU sensor, to calculate the rotation change of the posture of the electronic device.

For descriptions of the electronic image stabilization algorithm, refer to related descriptions in the general technology. To avoid repetition, details are not described herein again.

Step 201b. The electronic device obtains pixel coordinate data of feature points in the at least two video frames from the image data by using the electronic image stabilization algorithm.

Optionally, in this embodiment of this application, the feature points in the at least two video frames include a feature point in each of the at least two video frames.

Optionally, in this embodiment of this application, a feature point in a video frame may be a vertex, a corner point, or a center point in the video frame, or a point at which a grayscale value significantly changes in the video frame.

Optionally, in this embodiment of this application, a feature point of an image can reflect an essential feature of the image, and can identify a target object in the image, and image matching can be completed through feature point matching.

Optionally, in this embodiment of this application, pixel coordinate data of a pixel is used to indicate a geometric location of the pixel in a video frame.

For example, if coordinate data of a pixel is (a, b), a geometric location of the pixel in a video frame is a location that is a pixels away from the origin (usually a point in an upper left corner of the video frame) in an X-axis direction and b pixels away from the origin in a Y-axis direction.

Step 201c. The electronic device obtains the affine transformation matrix through calculation based on the pixel coordinate data and the first data by using the electronic image stabilization algorithm.

In this embodiment of this application, the pixel coordinate data is the pixel coordinate data of the feature points in the at least two video frames.

For a method in which the electronic device obtains the affine transformation matrix through calculation based on the pixel coordinate data, the angular velocity data, and the acceleration data, refer to related descriptions in the general technology. To avoid repetition, details are not described herein again.

In this embodiment of this application, the electronic device may input the image data of the at least two video frames and the first data into the electronic image stabilization algorithm to obtain the affine transformation matrix. Therefore, based on a motion estimation function of the electronic image stabilization algorithm, it may be ensured that the obtained affine transformation matrix can accurately indicate a mapping relationship between corresponding macroblocks in any two adjacent video frames of the at least two video frames.

Step 202. The electronic device determines a first object based on the affine transformation matrix.

The first object includes at least one of the following:

an encoding search range of each macroblock in the at least two video frames; or

an intra-coded frame of the at least two video frames.

In this embodiment of this application, an encoding search range of a macroblock is used to determine a macroblock that is in a next video frame of a video frame in which the macroblock is located and that is most similar to the macroblock (namely, a matching degree of a pixel value is greater than or equal to a preset threshold).

Optionally, in this embodiment of this application, the encoding search range may include an encoding search radius and an encoding search direction.

Optionally, in this embodiment of this application, an encoding search radius of a macroblock is used to indicate a size of an encoding search range of the macroblock.

For example, it is assumed that an encoding search radius of a macroblock 1 is a pixels. In this case, an encoding search range of the macroblock 1 is a circular range with a geometric location of the macroblock 1 in a video frame as the origin and a radius of a pixels.

Optionally, in this embodiment of this application, an encoding search direction of a macroblock is used to indicate a direction of an encoding search range of the macroblock relative to the macroblock.

For example, it is assumed that an encoding search direction of a macroblock 2 is a lower right direction. In this case, a direction of an encoding search range of the macroblock 2 is a lower right direction of the macroblock 2.

It may be learned that, an encoding search range of a macroblock may be narrowed to a relatively small range by using an encoding search radius and an encoding search direction of the macroblock, to determine a macroblock that is in a next video frame of a video frame in which the macroblock is located and that is most similar to the macroblock.

For descriptions of the intra-coded frame, refer to related descriptions in explanations of some nouns or terms in the specification and claims of this application. To avoid repetition, details are not described herein again.

The following describes in detail a method for determining the first object by the electronic device.

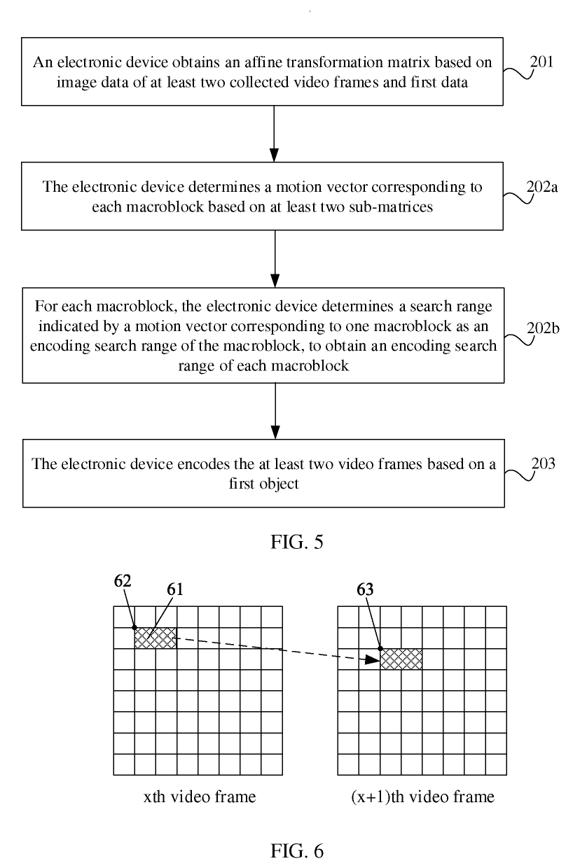

Optionally, in this embodiment of this application, the first object includes the encoding search range of each macroblock in the at least two video frames. For example, with reference to FIG. 1, as shown in FIG. 5, the foregoing step 202 may be implemented by using the following step 202a and step 202b.

Step 202a. The electronic device determines a motion vector corresponding to each macroblock based on the at least two sub-matrices.

Each motion vector indicates a search range.

Optionally, in this embodiment of this application, the electronic device may determine a motion vector corresponding to each macroblock in one of the at least two video frames based on any two adjacent sub-matrices of the at least two sub-matrices.

For example, a process in which the electronic device determines the motion vector corresponding to each macroblock in the at least two video frames may include the following 1~N:

1. The electronic device compares a change between a value of the 1st sub-matrix of the at least two sub-matrices and a value of the 2nd sub-matrix of the at least two sub-matrices, to determine a motion vector of each macroblock in the 1st video frame that is in the at least two video frames and that corresponds to the 1st sub-matrix.

2. The electronic device compares a change between the value of the 2nd sub-matrix of the at least two sub-matrices and a value of the 3rd sub-matrix of the at least two sub-matrices, to determine a motion vector of each macroblock in the 2nd video frame that is in the at least two video frames and that corresponds to the 2nd sub-matrix.

3. The electronic device compares a change between the value of the 3rd sub-matrix of the at least two sub-matrices and a value of the 4th sub-matrix of the at least two sub-matrices, to determine a motion vector of each macroblock in the 3rd video frame that is in the at least two video frames and that corresponds to the 3rd sub-matrix.

...

N–1. The electronic device compares a change between a value of a previous sub-matrix of the last sub-matrix of the at least two sub-matrices and a value of the last sub-matrix, to determine a motion vector of each macroblock in a previous video frame that is of the last video frame of the at least two video frames and that corresponds to the previous sub-matrix.

N. Because no motion estimation needs to be performed on a macroblock in the last video frame of the at least two video frames, the electronic device may determine a vector corresponding to each macroblock in the last video frame as 0.

In this way, the electronic device may determine the motion vector corresponding to each macroblock in the at least two video frames.

Step 202b. For each macroblock, the electronic device determines a search range indicated by a motion vector corresponding to one macroblock as an encoding search range of the macroblock, to obtain the encoding search range of each macroblock.

In this embodiment of this application, the motion vector includes a magnitude and a direction, and a search range may be determined by using a magnitude and a direction of a motion vector.

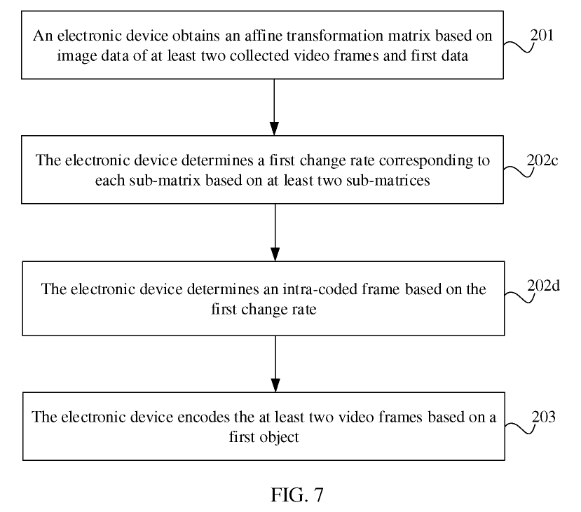

For example, as shown in FIG. 6, an xth video frame and an (x+1)th video frame are the any two adjacent video frames of the at least two video frames, and x is a positive integer. The electronic device may obtain geometric locations of pixels in the xth video frame and the (x+1)th video frame based on an xth sub-matrix corresponding to the xth video frame and an (x+1)th sub-matrix corresponding to the (x+1)th video frame. For example, coordinates of a pixel 62 in the xth video frame are (50, 50), and coordinates of a pixel 63 that is in the (x+1)th video frame and that corresponds to the pixel 62 are (100, 100). A motion vector corresponding to a macroblock 61 in the xth video frame may be determined. It may be learned that a search range indicated by the motion vector is a range with a radius of 50 pixels and a direction being a lower right direction of the macroblock 61. Therefore, the electronic device may determine the range as an encoding search range of the macroblock 61.

It may be understood that, after determining the search range indicated by the motion vector corresponding to each macroblock as the encoding search range of the corresponding macroblock, the electronic device obtains the encoding search range of each macroblock.

In this embodiment of this application, the electronic device may first determine the motion vector corresponding to each macroblock, and then determine the search range indicated by each motion vector as the encoding search range of the corresponding macroblock. Therefore, a process of determining the encoding search range of each macroblock may be simplified, thereby greatly reducing calculation complexity.

Optionally, in this embodiment of this application, the first object includes the intra-coded frame of the at least two video frames. For example, with reference to FIG. 1, as shown in FIG. 7, the foregoing step 202 may be implemented by using the following step 202c and step 202d.

Step 202c. The electronic device determines a first change rate corresponding to each sub-matrix based on the at least two sub-matrices.

A first change rate corresponding to one sub-matrix includes a change rate of a value in the sub-matrix relative to a value in a previous sub-matrix of the sub-matrix.

Optionally, in this embodiment of this application, a first change rate corresponding to one sub-matrix may be determined based on each value in the sub-matrix and a corresponding value in a previous sub-matrix of the sub-matrix.

For example, it is assumed that a sub-matrix 1 and a sub-matrix 2 are two adjacent sub-matrices of the at least two sub-matrices, the sub-matrix 1 is before the sub-matrix 2, the sub-matrix 1 is [a], and the sub-matrix 2 is [b]. In this case, a and b are corresponding values. Therefore, the electronic device may determine, based on a in the sub-matrix 1 and b in the sub-matrix 2, that a first change rate corresponding to the sub-matrix 2 is (b–a)/a.

For another example, it is assumed that a sub-matrix 3 and a sub-matrix 4 are two adjacent sub-matrices of the at least two sub-matrices, the sub-matrix 3 is before the sub-matrix 4, the sub-matrix 3 is [c1, d1], and the sub-matrix 4 is [c2, d2]. In this case, c1 and c2 are corresponding values, and d1 and d2 are corresponding values. Therefore, the electronic device may first separately obtain respective change rates, namely, (c2–c1)/c1 and (d2–d1)/d1, of the two groups of corresponding values based on c1 in the sub-matrix 1, c2 in the sub-matrix 2, d1 in the sub-matrix 1, and d2 in the sub-matrix 2, and then determine an average value of (c2–c1)/c1 and (d2–d1)/d1 as a first change rate corresponding to the sub-matrix 4.

Optionally, in this embodiment of this application, a process in which the electronic device determines the first change rate corresponding to each of the at least two sub-matrices may include the following a~n:

a. Because there is no sub-matrix before the 1st sub-matrix of the at least two sub-matrices, there is no change rate of a value in the 1st sub-matrix relative to a value in a previous sub-matrix of the 1st sub-matrix, and therefore the electronic device determines the first change rate corresponding to the 1st sub-matrix as 0.

b. The electronic device determines a first change rate corresponding to the 2nd sub-matrix of the at least two sub-matrices based on the value in the 1st sub-matrix of the at least two sub-matrices and a value in the 2nd sub-matrix.

b. The electronic device determines a first change rate corresponding to the 3rd sub-matrix of the at least two sub-matrices based on the value in the 2nd sub-matrix of the at least two sub-matrices and a value in the 3rd sub-matrix.

b. The electronic device determines a first change rate corresponding to the 4th sub-matrix of the at least two sub-matrices based on the value in the 3rd sub-matrix of the at least two sub-matrices and a value in the 4th sub-matrix.

n. The electronic device determines a first change rate corresponding to the last sub-matrix of the at least two sub-matrices based on a value in a previous sub-matrix of the last sub-matrix and a value in the last sub-matrix.

In this way, the electronic device may determine the first change rate corresponding to each sub-matrix.

Step 202d. The electronic device determines the intra-coded frame based on the first change rate.

In this embodiment of this application, the first change rate is the first change rate corresponding to each sub-matrix.

In this embodiment of this application, when determining the intra-coded frame of the at least two video frames, the electronic device may directly determine the intra-coded frame based on the determined first change rate corresponding to each sub-matrix, without comparing pixel changes of macroblocks in the at least two video frames. Therefore, a process of determining the intra-coded frame can be simplified, thereby reducing calculation complexity.

The following describes in detail a method for determining the intra-coded frame by the electronic device based on the first change rate corresponding to each sub-matrix.

Optionally, in this embodiment of this application, the electronic device may determine the intra-coded frame based on the first change rate corresponding to each sub-matrix in the following Manner 1 or Manner 2.

Manner 1

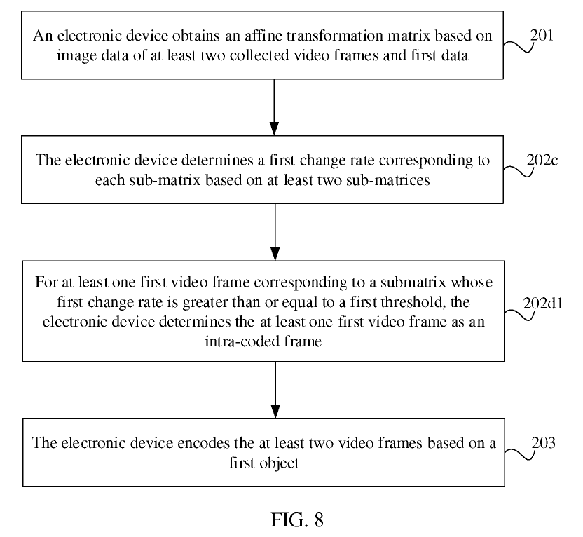

Optionally, in this embodiment of this application, with reference to FIG. 7, as shown in FIG. 8, the foregoing step 202d may be implemented by using the following step 202d1.

Step 202d1. For at least one first video frame corresponding to a sub-matrix whose first change rate is greater than or equal to a first threshold, the electronic device determines the at least one first video frame as the intra-coded frame.

Optionally, in this embodiment of this application, the first threshold may be system-default, or may be set by a user based on an actual use requirement.

Optionally, in this embodiment of this application, the first threshold may be any value such as 50%, 60%, or 70%.

For example, it is assumed that the at least two sub-matrices are successively a sub-matrix A, a sub-matrix B, and a sub-matrix C, and the first threshold is 60%. In this case, if the electronic device determines that a first change rate corresponding to the sub-matrix A is 0, a first change rate corresponding to the sub-matrix B is 50%, and a first change rate corresponding to the sub-matrix C is 68%, the electronic device may determine a video frame corresponding to the sub-matrix C as the intra-coded frame.

In this embodiment of this application, the at least one first video frame is a video frame of the at least two video frames.

Optionally, in this embodiment of this application, each sub-matrix that is of the at least two sub-matrices and whose first change rate is greater than or equal to the first threshold corresponds to one of the at least one first video frame.

Manner 2

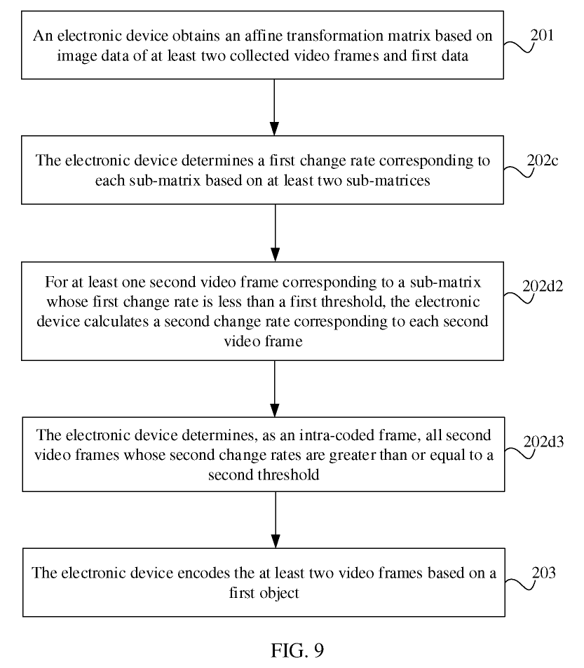

Optionally, in this embodiment of this application, with reference to FIG. 7, as shown in FIG. 9, the foregoing step 202d may be implemented by using the following step 202d2 and step 202d3.

Step 202d2. For at least one second video frame corresponding to a sub-matrix whose first change rate is less than a first threshold, the electronic device calculates a second change rate corresponding to each second video frame.

A second change rate corresponding to one second video frame includes a change rate of a pixel value of a pixel in the second video frame relative to a pixel value of a pixel in a previous video frame of the second video frame.

For descriptions of calculating, by the electronic device, the second change rate corresponding to each second video frame, refer to related descriptions in the general technology. To avoid repetition, details are not described herein again.

Step 202d3. The electronic device determines, as the intra-coded frame, all second video frames whose second change rates are greater than or equal to a second threshold.

Optionally, in this embodiment of this application, the second threshold may be system-default, or may be set by a user based on an actual use requirement.

Optionally, in this embodiment of this application, the second threshold may be any value such as 65%, 75%, or 80%.

For example, it is assumed that the at least two sub-matrices are successively a sub-matrix a, a sub-matrix b, and a sub-matrix c, the first threshold is 60%, and the second threshold is 75%. In this case, if the electronic device determines that a first change rate corresponding to the sub-matrix a is 0, a first change rate corresponding to the sub-matrix b is 50%, and a first change rate corresponding to the sub-matrix c is 68%, the electronic device may directly determine a video frame corresponding to the sub-matrix c as the intra-coded frame, and then calculate a second change rate corresponding to a video frame (hereinafter referred to as a video frame a) corresponding to the sub-matrix a and a second change rate corresponding to a video frame (hereinafter referred to as a video frame b) corresponding to the sub-matrix b. If the second change rate that corresponds to the video frame a and that is obtained by the electronic device through calculation is 0, and the second change rate that corresponds to the video frame b and that is obtained by the electronic device through calculation is 78%, the electronic device may also determine the video frame b as the intra-coded frame.

In this embodiment of this application, the at least one second video frame is a video frame of the at least two video frames.

Optionally, in this embodiment of this application, the electronic device may determine, as a P/B-frame, a second video frame that is in the at least one second video frame and whose second change rate is less than the second threshold.

In this embodiment of this application, the electronic device may directly determine, as the intra-coded frame, at least one first video frame corresponding to a sub-matrix whose first change rate is greater than or equal to the first threshold, or may first calculate a second change rate of a second video frame corresponding to each sub-matrix whose first change rate is less than the first threshold, and determine, as the intra-coded frame, all second video frames whose second change rates are greater than or equal to the second threshold. Therefore, flexibility in determining the intra-coded frame can be improved.

Optionally, in this embodiment of this application, after obtaining the affine transformation matrix, the electronic device may transmit the affine transformation matrix and the image data of the at least two video frames to an encoder in the electronic device, and then determine the first object based on the affine transformation matrix by using the encoder.

Optionally, in this embodiment of this application, the encoder is a device that encodes and converts a signal (for example, a bitstream) or data into a signal form that can be used for communication, transmission, and storage. The encoder converts angular displacement or linear displacement into an electrical signal. The former is referred to as a code disk, and the latter is referred to as a code scale.

Optionally, in this embodiment of this application, the encoder may be an incremental encoder or an absolute encoder. The incremental encoder converts displacement into a periodic electrical signal, then converts the electrical signal into a counting pulse, and represents a magnitude of the displacement by using a quantity of pulses. For the absolute encoder, each location corresponds to a determined digital code. Therefore, an indicated value thereof is only related to start and end locations of the measurement, but is not related to an intermediate process of the measurement.

Step 203. The electronic device encodes the at least two video frames based on the first object.

Optionally, in this embodiment of this application, the electronic device encodes the at least two video frames based on the encoding search range, and may identify redundant information between the at least two video frames, to perform compression processing on the redundant information.

Optionally, in this embodiment of this application, the electronic device encodes the at least two video frames based on the intra-coded frame. This may increase a video frame compression rate, and reduce a volume of an encoded video.

For a method for encoding the video frame by the electronic device, refer to related descriptions in the general technology. To avoid repetition, details are not described herein again.

According to the video encoding method provided in this embodiment of this application, when determining the encoding search range of each macroblock in the at least two collected video frames, the electronic device may directly determine the encoding search range based on the affine transformation matrix used to indicate a mapping relationship between corresponding macroblocks in adjacent video frames, without traversing a plurality of pixels around each pixel in each macroblock. In addition, when determining the intra-coded frame of the at least two video frames, the electronic device may also directly determine the intra-coded frame based on the affine transformation matrix, without comparing pixel changes of macroblocks in the at least two video frames. Therefore, when the at least two video frames are encoded based on at least one of the encoding search range or the intra-coded frame, computing load of the electronic device can be greatly reduced, thereby reducing power consumption of the electronic device.

The foregoing method embodiments or various possible implementations in the foregoing method embodiments may be separately performed, or may be performed in combination with each other without a contradiction. This may be determined based on an actual use requirement. This is not limited in the embodiments of this application.

The video encoding method provided in the embodiments of this application may be performed by a video encoding apparatus. In the embodiments of this application, that the video encoding apparatus performs the video encoding method is used as an example to describe the video encoding apparatus provided in the embodiments of this application.

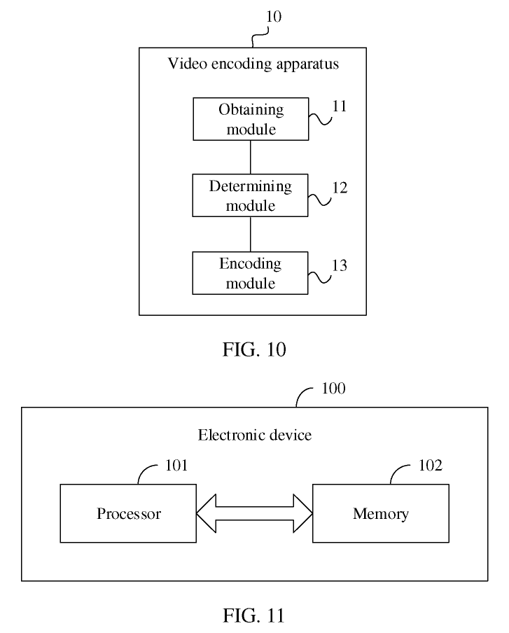

As shown in FIG. 10, an embodiment of this application provides a video encoding apparatus 10. The video encoding apparatus 80 may include an obtaining module 11, a determining module 12, and an encoding module 13.

The obtaining module 11 may be configured to obtain an affine transformation matrix based on image data of at least two collected video frames and first data, where the affine transformation matrix is used to indicate a mapping relationship between corresponding macroblocks in every two adjacent video frames of the at least two video frames, and the first data is acceleration data and angular velocity data of an electronic device in a process of collecting the at least two video frames. The determining module 12 may be configured to determine a first object based on the affine transformation matrix obtained by the obtaining module 11. The encoding module 13 may be configured to encode the at least two video frames based on the first object determined by the determining module 12. The first object includes at least one of the following: an encoding search range of each macroblock in the at least two video frames, or an intra-coded frame of the at least two video frames.

In a possible implementation, the affine transformation matrix may include at least two sub-matrices, each sub-matrix corresponds to one of the at least two video frames, and each sub-matrix is used to indicate a geometric location of a macroblock in a corresponding video frame.

In a possible implementation, the first object includes the encoding search range of each macroblock in the at least two video frames. The determining module 12 may be configured to: determine a motion vector corresponding to each macroblock based on the at least two sub-matrices, where each motion vector indicates a search range; and for each macroblock, determine a search range indicated by a motion vector corresponding to one macroblock as an encoding search range of the macroblock, to obtain the encoding search range of each macroblock.

In a possible implementation, the first object includes the intra-coded frame of the at least two video frames. The determining module 12 may be configured to: determine a first change rate corresponding to each of the at least two sub-matrices based on the at least two sub-matrices, and determine the intra-coded frame based on the first change rate. A first change rate corresponding to one sub-matrix includes a change rate of a value in the sub-matrix relative to a value in a previous sub-matrix of the sub-matrix.

In a possible implementation, the determining module 12 may be configured to: for at least one first video frame corresponding to a sub-matrix whose first change rate is greater than or equal to a first threshold, determine the at least one first video frame as the intra-coded frame; or for at least one second video frame corresponding to a sub-matrix whose first change rate is less than a first threshold, calculate a second change rate corresponding to each second video frame, where a second change rate corresponding to one second video frame includes a change rate of a pixel value of a pixel in the second video frame relative to a pixel value of a pixel in a previous video frame of the second video frame; and determine, as the intra-coded frame, all second video frames whose second change rates are greater than or equal to a second threshold.

In a possible implementation, the obtaining module 11 may be configured to: input the image data and the first data into an electronic image stabilization algorithm, obtain pixel coordinate data of feature points in the at least two video frames from the image data by using the electronic image stabilization algorithm, and obtain the affine transformation matrix through calculation based on the pixel coordinate data and the first data by using the electronic image stabilization algorithm.

According to the video encoding apparatus provided in this embodiment of this application, when determining the encoding search range of each macroblock in the at least two collected video frames, the video encoding apparatus may directly determine the encoding search range based on the affine transformation matrix used to indicate a mapping relationship between corresponding macroblocks in adjacent video frames, without traversing a plurality of pixels around each pixel in each macroblock. In addition, when determining the intra-coded frame of the at least two video frames, the video encoding apparatus may also directly determine the intra-coded frame based on the affine transformation matrix, without comparing pixel changes of macroblocks in the at least two video frames. Therefore, when the at least two video frames are encoded based on at least one of the encoding search range or the intra-coded frame, computing load can be greatly reduced, thereby reducing power consumption.

The video encoding apparatus in this embodiment of this application may be an electronic device, or may be a component such as an integrated circuit or a chip in an electronic device. The electronic device may be a terminal, or may be another device different from a terminal. For example, the electronic device may be a mobile phone, a tablet computer, a notebook computer, a palmtop computer, a vehicle-mounted electronic device, a mobile Internet device (MID), an augmented reality (AR)/virtual reality (VR) device, a robot, a wearable device, an ultra-mobile personal computer (UMPC), a netbook or a personal digital assistant (PDA), or the like; or may be a server, a network attached storage (NAS), a personal computer (PC), a television (TV), a teller machine, a self-service machine, or the like. This is not limited in this embodiment of this application.

The video encoding apparatus in this embodiment of this application may be an apparatus having an operating system. The operating system may be an Android operating system, may be an iOS operating system, or may be another possible operating system. This is not limited in this embodiment of this application.

The video encoding apparatus provided in this embodiment of this application can implement all the processes implemented in the foregoing method embodiments. To avoid repetition, details are not described herein again.

As shown in FIG. 11, an embodiment of this application further provides an electronic device 100, including a processor 101 and a memory 102. The memory 102 stores a program or instructions executable on the processor 101. When the program or the instructions are executed by the processor 101, the steps in the foregoing video encoding method embodiments are implemented, and same technical effect can be achieved. To avoid repetition, details are not described herein again.

It should be noted that the electronic device in this embodiment of this application includes a mobile electronic device and a non-mobile electronic device.

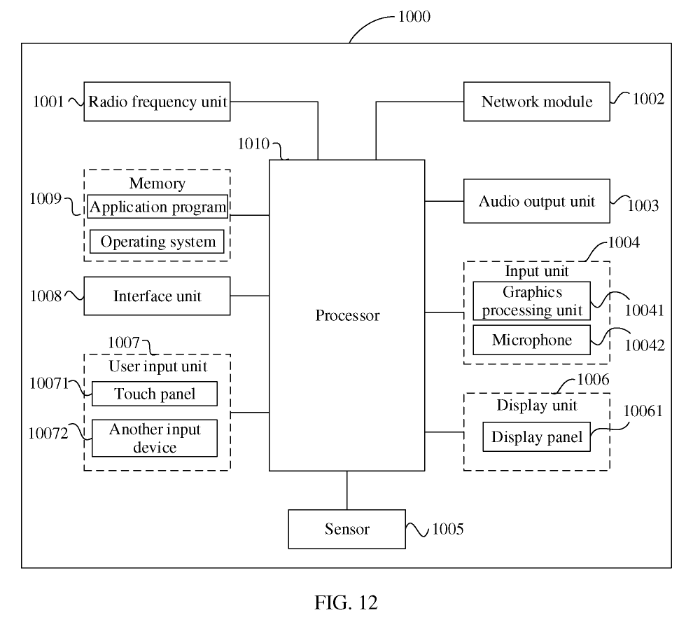

FIG. 12 is a schematic diagram of a hardware structure of an electronic device according to an embodiment of this application.

As shown in FIG. 12, the electronic device 1000 includes but is not limited to components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art may understand that the electronic device 1000 may further include a power supply (for example, a battery) that supplies power to each component, and the power supply may be logically connected to the processor 1010 by using a power management system, to implement functions such as charging management, discharging management, and power consumption management by using the power management system. A structure of the electronic device shown in FIG. 12 constitutes no limitation on the electronic device. The electronic device may include more or fewer components than those shown in the figure, or combine some components, or have different component arrangements. Details are not described herein again.

The processor 1010 may be configured to obtain an affine transformation matrix based on image data of at least two collected video frames and first data, where the affine transformation matrix is used to indicate a mapping relationship between corresponding macroblocks in every two adjacent video frames of the at least two video frames, and the first data is acceleration data and angular velocity data of an electronic device in a process of collecting the at least two video frames. The processor 1010 may be further configured to determine a first object based on the obtained affine transformation matrix. The processor 1010 may be further configured to encode the at least two video frames based on the determined first object. The first object includes at least one of the following: an encoding search range of each macroblock in the at least two video frames, or an intra-coded frame of the at least two video frames.

In a possible implementation, the affine transformation matrix may include at least two sub-matrices, each sub-matrix corresponds to one of the at least two video frames, and each sub-matrix is used to indicate a geometric location of a macroblock in a corresponding video frame.

In a possible implementation, the first object includes the encoding search range of each macroblock in the at least two video frames. The processor 1010 may be configured to: determine a motion vector corresponding to each macroblock based on the at least two sub-matrices, where each motion vector indicates a search range; and for each macroblock, determine a search range indicated by a motion vector corresponding to one macroblock as an encoding search range of the macroblock, to obtain the encoding search range of each macroblock.

In a possible implementation, the first object includes the intra-coded frame of the at least two video frames. The processor 1010 may be configured to: determine a first change rate corresponding to each of the at least two sub-matrices based on the at least two sub-matrices, and determine the intra-coded frame based on the first change rate. A first change rate corresponding to one sub-matrix includes a change rate of a value in the sub-matrix relative to a value in a previous sub-matrix of the sub-matrix.

In a possible implementation, the processor 1010 may be configured to: for at least one first video frame corresponding to a sub-matrix whose first change rate is greater than or equal to a first threshold, determine the at least one first video frame as the intra-coded frame; or for at least one second video frame corresponding to a sub-matrix whose first change rate is less than a first threshold, calculate a second change rate corresponding to each second video frame, where a second change rate corresponding to one second video frame includes a change rate of a pixel value of a pixel in the second video frame relative to a pixel value of a pixel in a previous video frame of the second video frame; and determine, as the intra-coded frame, all second video frames whose second change rates are greater than or equal to a second threshold.

In a possible implementation, the processor 1010 may be configured to: input the image data and the first data into an electronic image stabilization algorithm, obtain pixel coordinate data of feature points in the at least two video frames from the image data by using the electronic image stabilization algorithm, and obtain the affine transformation matrix through calculation based on the pixel coordinate data and the first data by using the electronic image stabilization algorithm.

According to the electronic device provided in this embodiment of this application, when determining the encoding search range of each macroblock in the at least two collected video frames, the electronic device may directly determine the encoding search range based on the affine transformation matrix used to indicate a mapping relationship between corresponding macroblocks in adjacent video frames, without traversing a plurality of pixels around each pixel in each macroblock. In addition, when determining the intra-coded frame of the at least two video frames, the electronic device may also directly determine the intra-coded frame based on the affine transformation matrix, without comparing pixel changes of macroblocks in the at least two video frames. Therefore, when the at least two video frames are encoded based on at least one of the encoding search range or the intra-coded frame, computing load of the electronic device can be greatly reduced, thereby reducing power consumption of the electronic device.

It should be understood that, in this embodiment of this application, the input unit 1004 may include a graphics processing unit (GPU) 10041 and a microphone 10042, and the GPU 10041 processes image data of a still picture or a video obtained by an image capture apparatus (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 or another input device 10072. The touch panel 10071 is also referred to as a touchscreen. The touch panel 10071 may include two parts: a touch detection apparatus and a touch controller. The another input device 10072 may include but is not limited to a physical keyboard, a function key (such as a volume control key or an on/off key), a trackball, a mouse, and an operating lever. Details are not described herein again.

The memory 1009 may be configured to store a software program and various data. The memory 1009 can mainly include a first storage area for storing a program or instructions and a second storage area for storing data. The first storage area can store an operating system, an application program or instructions required by at least one function (for example, a sound play function or an image play function), and the like. In addition, the memory 1009 can include a volatile memory or a nonvolatile memory, or the memory 1009 can include both a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 1009 in this embodiment of this application includes but is not limited to these memories and any other suitable type of memory.

The processor 1010 may include one or more processing units. Optionally, the processor 1010 integrates an application processor and a modem processor. The application processor mainly processes operations related to an operating system, a user interface, an application program, and the like. The modem processor, for example, a baseband processor, mainly processes a wireless communication signal. It can be understood that, the foregoing modem processor may not be integrated into the processor 1010.

An embodiment of this application further provides a non-transitory readable storage medium. The non-transitory readable storage medium stores a program or instructions. When the program or the instructions are executed by a processor, the processes in the foregoing video encoding method embodiments are implemented, and same technical effects can be achieved. To avoid repetition, details are not described herein again.

The processor is a processor in the electronic device in the foregoing embodiments. The non-transitory readable storage medium includes a non-transitory computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement the processes in the foregoing video encoding method embodiments, and same technical effects can be achieved. To avoid repetition, details are not described herein again.

It should be understood that, the chip mentioned in this embodiment of this application may also be referred to as a system-level chip, a system chip, a chip system, or a system on chip.

An embodiment of this application provides a computer program product. The program product is stored in a non-transitory storage medium. The program product is executed by at least one processor to implement the processes in the foregoing video encoding method embodiments, and same technical effects can be achieved. To avoid repetition, details are not described herein again.

It should be noted that in this specification, the term "include", "comprise", or any of their variants is intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by "includes a …" does not preclude the existence of additional identical elements in the process, method, article, or apparatus that includes the element. In addition, it should be noted that, the scope of the method and apparatus in the implementations of this application is not limited to performing functions in a sequence shown or discussed, and may further include performing functions in a basically simultaneous manner or in a reverse order based on the functions involved. For example, the described method may be performed in an order different from the order described, and various steps may be added, omitted, or combined. In addition, features described with reference to some examples can be combined in other examples.

According to the foregoing descriptions of the implementations, a person skilled in the art can clearly understand that the method in the foregoing embodiments can be implemented by software and a necessary general-purpose hardware platform, or certainly can be implemented by hardware. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, a network device, or the like) to perform the methods described in the embodiments of this application.

The foregoing describes the embodiments of this application with reference to the accompanying drawings. However, this application is not limited to the foregoing implementations. The foregoing implementations are merely illustrative rather than restrictive. Inspired by this application, a person of ordinary skill in the art may develop many other manners without departing from principles of this application and the protection scope of the claims, and all such manners fall within the protection scope of this application.

What is claimed is:

1. A video encoding method, comprising:
obtaining an affine transformation matrix based on image data of at least two collected video frames and first data, wherein the affine transformation matrix is used to indicate a mapping relationship between corresponding macroblocks in every two adjacent video frames of the at least two video frames, and the first data is acceleration data and angular velocity data of an electronic device in a process of collecting the at least two video frames;
determining a first object based on the affine transformation matrix; and
encoding the at least two video frames based on the first object, wherein
the first object comprises at least one of the following:
an encoding search range of each macroblock in the at least two video frames; or
an intra-coded frame of the at least two video frames.

2. The method according to claim 1, wherein the affine transformation matrix comprises at least two sub-matrices, each sub-matrix corresponds to one of the at least two video frames, and each sub-matrix is used to indicate a geometric location of a macroblock in a corresponding video frame.

3. The method according to claim 2, wherein the first object comprises the encoding search range of each macroblock; and
the determining a first object based on the affine transformation matrix comprises:
determining a motion vector corresponding to each macroblock based on the at least two sub-matrices, wherein each motion vector indicates a search range; and
for each macroblock, determining a search range indicated by a motion vector corresponding to one macroblock as an encoding search range of the macroblock, to obtain the encoding search range of each macroblock.

4. The method according to claim 2, wherein the first object comprises the intra-coded frame; and
the determining a first object based on the affine transformation matrix comprises:
determining a first change rate corresponding to each sub-matrix based on the at least two sub-matrices; and
determining the intra-coded frame based on the first change rate, wherein
a first change rate corresponding to one sub-matrix comprises a change rate of a value in the sub-matrix relative to a value in a previous sub-matrix of the sub-matrix.

5. The method according to claim 4, wherein the determining the intra-coded frame based on the first change rate comprises:
for at least one first video frame corresponding to a sub-matrix whose first change rate is greater than or equal to a first threshold, determining the at least one first video frame as the intra-coded frame;
or
for at least one second video frame corresponding to a sub-matrix whose first change rate is less than a first threshold, calculating a second change rate corresponding to each second video frame, wherein a second change rate corresponding to one second video frame comprises a change rate of a pixel value of a pixel in the second video frame relative to a pixel value of a pixel in a previous video frame of the second video frame; and
determining, as the intra-coded frame, all second video frames whose second change rates are greater than or equal to a second threshold.

6. The method according to claim 1, wherein the obtaining an affine transformation matrix based on image data of at least two collected video frames and first data comprises:
inputting the image data and the first data into an electronic image stabilization algorithm;
obtaining pixel coordinate data of feature points in the at least two video frames from the image data by using the electronic image stabilization algorithm; and
obtaining the affine transformation matrix through calculation based on the pixel coordinate data and the first data by using the electronic image stabilization algorithm.

7. An electronic device, comprising a processor and a memory, wherein the memory stores a program or instructions executable on the processor, and the program or the instructions, when executed by the processor, cause the electronic device to perform:
obtaining an affine transformation matrix based on image data of at least two collected video frames and first data, wherein the affine transformation matrix is used to indicate a mapping relationship between corresponding macroblocks in every two adjacent video frames of the at least two video frames, and the first data is acceleration data and angular velocity data of the electronic device in a process of collecting the at least two video frames;
determining a first object based on the affine transformation matrix; and
encoding the at least two video frames based on the first object, wherein
the first object comprises at least one of the following:
an encoding search range of each macroblock in the at least two video frames; or
an intra-coded frame of the at least two video frames.

8. The electronic device according to claim 7, wherein the affine transformation matrix comprises at least two sub-matrices, each sub-matrix corresponds to one of the at least two video frames, and each sub-matrix is used to indicate a geometric location of a macroblock in a corresponding video frame.

9. The electronic device according to claim 8, wherein the first object comprises the encoding search range of each macroblock; and
the program or the instructions, when executed by the processor, cause the electronic device to perform:
determining a motion vector corresponding to each macroblock based on the at least two sub-matrices, wherein each motion vector indicates a search range; and
for each macroblock, determining a search range indicated by a motion vector corresponding to one macroblock as an encoding search range of the macroblock, to obtain the encoding search range of each macroblock.

10. The electronic device according to claim 8, wherein the first object comprises the intra-coded frame; and
the program or the instructions, when executed by the processor, cause the electronic device to perform:
determining a first change rate corresponding to each sub-matrix based on the at least two sub-matrices; and
determining the intra-coded frame based on the first change rate, wherein
a first change rate corresponding to one sub-matrix comprises a change rate of a value in the sub-matrix relative to a value in a previous sub-matrix of the sub-matrix.

11. The electronic device according to claim 10, wherein the program or the instructions, when executed by the processor, cause the electronic device to perform:
for at least one first video frame corresponding to a sub-matrix whose first change rate is greater than or equal to a first threshold, determining the at least one first video frame as the intra-coded frame;
or
for at least one second video frame corresponding to a sub-matrix whose first change rate is less than a first threshold, calculating a second change rate corresponding to each second video frame, wherein a second change rate corresponding to one second video frame comprises a change rate of a pixel value of a pixel in the second video frame relative to a pixel value of a pixel in a previous video frame of the second video frame; and
determining, as the intra-coded frame, all second video frames whose second change rates are greater than or equal to a second threshold.

12. The electronic device according to claim 7, wherein the program or the instructions, when executed by the processor, cause the electronic device to perform:
inputting the image data and the first data into an electronic image stabilization algorithm;
obtaining pixel coordinate data of feature points in the at least two video frames from the image data by using the electronic image stabilization algorithm; and
obtaining the affine transformation matrix through calculation based on the pixel coordinate data and the first data by using the electronic image stabilization algorithm.

13. A non-transitory readable storage medium, wherein the non-transitory readable storage medium stores a program or instructions, and the program or the instructions, when executed by a processor of an electronic device, cause the electronic device to perform:
obtaining an affine transformation matrix based on image data of at least two collected video frames and first data, wherein the affine transformation matrix is used to indicate a mapping relationship between corresponding macroblocks in every two adjacent video frames of the at least two video frames, and the first data is acceleration data and angular velocity data of the electronic device in a process of collecting the at least two video frames;
determining a first object based on the affine transformation matrix; and
encoding the at least two video frames based on the first object, wherein
the first object comprises at least one of the following:
an encoding search range of each macroblock in the at least two video frames; or
an intra-coded frame of the at least two video frames.

14. The non-transitory readable storage medium according to claim 13, wherein the affine transformation matrix comprises at least two sub-matrices, each sub-matrix corresponds to one of the at least two video frames, and each sub-matrix is used to indicate a geometric location of a macroblock in a corresponding video frame.

15. The non-transitory readable storage medium according to claim 14, wherein the first object comprises the encoding search range of each macroblock; and
the program or the instructions, when executed by the processor, cause the electronic device to perform:
determining a motion vector corresponding to each macroblock based on the at least two sub-matrices, wherein each motion vector indicates a search range; and
for each macroblock, determining a search range indicated by a motion vector corresponding to one macroblock as an encoding search range of the macroblock, to obtain the encoding search range of each macroblock.

16. The non-transitory readable storage medium according to claim 14, wherein the first object comprises the intra-coded frame; and
the program or the instructions, when executed by the processor, cause the electronic device to perform:
determining a first change rate corresponding to each sub-matrix based on the at least two sub-matrices; and
determining the intra-coded frame based on the first change rate, wherein
a first change rate corresponding to one sub-matrix comprises a change rate of a value in the sub-matrix relative to a value in a previous sub-matrix of the sub-matrix.

17. The non-transitory readable storage medium according to claim 16, wherein the program or the instructions, when executed by the processor, cause the electronic device to perform:
for at least one first video frame corresponding to a sub-matrix whose first change rate is greater than or equal to a first threshold, determining the at least one first video frame as the intra-coded frame;
or
for at least one second video frame corresponding to a sub-matrix whose first change rate is less than a first threshold, calculating a second change rate corresponding to each second video frame, wherein a second change rate corresponding to one second video frame comprises a change rate of a pixel value of a pixel in the second video frame relative to a pixel value of a pixel in a previous video frame of the second video frame; and
determining, as the intra-coded frame, all second video frames whose second change rates are greater than or equal to a second threshold.

18. The non-transitory readable storage medium according to claim 13, wherein the program or the instructions, when executed by the processor, cause the electronic device to perform:
inputting the image data and the first data into an electronic image stabilization algorithm;
obtaining pixel coordinate data of feature points in the at least two video frames from the image data by using the electronic image stabilization algorithm; and
obtaining the affine transformation matrix through calculation based on the pixel coordinate data and the first data by using the electronic image stabilization algorithm.
